(19) United States
(12) Patent Application Publication
(10) Pub. No.: US 2010/0325069 A1
(43) Pub. Date: Dec. 23, 2010

(54) Advertising medium for Ads to Nature to eliminate plastic bags

(75) Inventor: Camilo A. Ferro, Chicago, IL (US)

Correspondence Address: Camilo A. Ferro, 3501 N. Southport #181, Chicago, IL, 60614, US

(73) Assignee: Camilo A. Ferro

(21) Appl. No.: 12/817,182

(22) Filed: Jun. 17, 2010

Related U.S. Application Data
(60) Provisional application No. 61/187,988, filed on Jun. 17, 2009.

(51) Int. Cl. G06Q 90/00; B65D 33/00

(52) U.S. Cl. 705/500; 383/105

(57) ABSTRACT

Disclosed is a method for replacing non-degradable plastic bags with better bags, such as bio-degradable plastic bags, paper bags, or, preferably, compostable bags. The method facilitates the use of better bags by using them as an advertising medium. Thus the method of coordinating third party advertising comprises (a) contacting a first party to manufacture at least one bag; (b) contacting a second party to receive the bag for consumer use; (c) contacting a third party to solicit advertising; (d) providing said advertising to first party by coordinating effective manufacturing machining; and (e) monitoring distribution of bags from first party to second party and then to consumers. The invention also provides a bag having third party advertising wherein advertising is distributed by a second party direct to consumers, and wherein the bag is manufactured by a first party using a machine plate with advertising from the third party, and wherein the bag is provided at substantially no cost to the second party.

### CROSS-REFERENCE TO RELATED APPLICATIONS

This patent application claims the benefit of U.S. Provisional Patent Application No. 61/187,988, filed Jun. 17,2009.

### BACKGROUND OF THE INVENTION

Solutions are being continuously sought for ways to improve advertising mediums and to target new and existing markets. Solutions are also being continuously sought for ways to help improve the environment and maintain the sustainability of the world around us all. For instance, some local governments have banned or taxed use of poorly degradable plastic bags as one way to improve the environment.

### BRIEF SUMMARY OF THE INVENTION

In view of the foregoing, it is an object of the invention to provide a method for replacing poorly or non-degradable plastic bags with better bags, such as bio-degradable plastic bags, paper bags, or, preferably, compostable bags.

It is a related object of the invention to provide the ability to facilitate the use of better bags by using the bags as an advertising medium, preferably targeted to local clientele.

These objects are achieved by the present invention, which provides a method of coordinating third party advertising comprising the steps of: (a) contacting a first party to manufacture at least one bag; (b) contacting a second party to receive the bag for consumer use; (c) contacting a third party to solicit advertising; (d) providing said advertising to first party by coordinating effective manufacturing machining; and (e) monitoring distribution of the bag or bags from first party to second party and then to consumers.

The invention also provides a bag comprising third party advertising wherein said advertising is distributed by a second party direct to consumers, wherein said bag is manufactured by a first party using a machine plate representing solicited advertising from the third party, and wherein said bag is provided free or at substantially no cost to the second party.

The invention further provides a method of coordinating third party advertising on consumer bags comprising the steps of: (a) contacting a first party to manufacture at least one compostable bag; (b) contacting a second party to receive the bag at a substantially minimal or free price for consumer use; (c) contacting a third party to solicit advertising; (d) providing said advertising to first party by coordinating effective manufacturing machining; (e) monitoring distribution of the bag or bags from first party to second party and then to consumers; and (f) reporting distribution to third party and soliciting additional advertising.

Additional objects, embodiments and details of this invention can be obtained from the following detailed description of the invention.

### DETAILED DESCRIPTION OF THE INVENTION

In one embodiment, the invention is a method of coordinating third party advertising. The method may be performed in any order and include the following steps: (a) contacting a first party to manufacture at least one bag; (b) contacting a second party to receive the bag for consumer use; (c) contacting a third party to solicit advertising; (d) providing said advertising to first party by coordinating effective manufacturing machining; and (e) monitoring distribution of the bag or bags from first party to second party and then to consumers. The bag used can be selected from the group consisting of a paper bag, a compostable bag, and a plastic bag. The bag may also be a combination of paper, compostable material, or plastic. Preferably if any plastic is selected, it is biodegradable plastic. One preferred bag of the invention is a compostable bag. The invention also has an optional step of reporting bag distribution to the third party. The invention also has an optional step of returning to contact the third party to solicit additional advertising.

In some embodiments, the method comprises coordination of effective manufacturing machining that includes selecting a plate representing the advertising. Preferably a fourth party owns the plate. The fourth party also performs the method in some preferred embodiments. In other embodiments, the first, second, or third party may perform any or all of the steps.

In other embodiments, the method of is characterized with a price paid for the bag by the second party as being substantially minimal or is nothing. In other words, the bag is provided free or at substantially minimal cost. Furthermore, in some embodiments, the advertising comprises coupons or other similar means that facilitate at least partially effective bag recycling.

In another embodiment, the invention is a bag comprising third party advertising wherein said advertising is distributed by a second party direct to consumers, wherein said bag is manufactured by a first party using a machine plate representing solicited advertising from the third party, and wherein said bag is provided free or at substantially no cost to the second party. Preferably the bag comprises a bag selected from the group consisting of a paper bag, a compostable bag, a plastic bag, and mixtures thereof. More preferably, the bag is a compostable bag. The bag may further include a slogan or a logo representing the second party. And the bag in some embodiments comprises recyclable material, in whole or in part.

Typical advertising is well known for many third parties, including advertising through mediums like newspapers, taxis, trains, buses, radio, TV commercials, and on the Internet, all of which reaches many types of markets and audiences. In the present invention, the medium of advertising is a bag. A bag gives an opportunity to advertise on a medium that is taken home by consumers in many different ways. In some embodiments of the invention, such advertising may be distributed to consumers via second parties that can include, for example and without limitation, grocery stores, small food and retail stores/brick and mortar locations. In preferred embodiments, the local second parties target their local clientele by bags selected for their specific area. Benefits to these second parties, such as grocery stores, restaurants, retailers, pharmacies, convenience stores and the like, include having targeted t-shirt type bags, news paper bags, sandwich bags, or dry cleaning bags, etc. that do not require paying any applicable civil or tax penalties for utilizing non-degradable plastic materials, and include having the ability to offer an environmentally friendly and sustainable solution to consumers by removing poorly-degradable plastic bags from use. Benefits to consumers include that they no longer have to worry about bringing in their own environmentally friendly bag, they do not have to worry about getting charged extra for plastic bags, and they also get comfort knowing that they are doing their part to save the environment. In preferred embodiments of the invention, a fourth party works with a first party manufacturer to facilitate getting the bags to the second parties (and from there to consumers) by using advertising to subsidize the cost, so the bags can be substantially free to the end-user(s).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of coordinating third party advertising comprising the steps of:
(a) contacting a first party to manufacture at least one bag;
(b) contacting a second party to receive the bag for consumer use;
(c) contacting a third party to solicit advertising;
(d) providing said advertising to first party by coordinating effective manufacturing machining; and
(e) monitoring distribution of the bag or bags from first party to second party and then to consumers.

2. The method of claim 1, wherein the bag comprises a bag selected from the group consisting of a paper bag, a compostable bag, a plastic bag, and mixtures thereof.

3. The method of claim 2, wherein the bag is a compostable bag.

4. The method of claim 2, wherein the bag is a plastic bag characterized with bio-degradable plastic.

5. The method of claim 1, further comprising the step of reporting distribution to third party.

6. The method of claim 1, wherein the effective manufacturing machining comprises selecting a plate representing said advertising.

7. The method of claim 6, wherein the plate is owned by a fourth party.

8. The method of claim 1, further comprising the step of returning to contact the third party to solicit additional advertising.

9. The method of claim 1, wherein a price paid for the bag by the second party is substantially minimal or is nothing.

10. The method of claim 1, wherein said method is performed by any one of the first party, second party, or third party.

11. The method of claim 1, wherein said method is performed by a fourth party.

12. The method of claim 1, wherein the advertising comprises coupons that facilitate at least partially effective bag recycling.

13. A bag comprising third party advertising wherein said advertising is distributed by a second party direct to consumers, wherein said bag is manufactured by a first party using a machine plate representing solicited advertising from the third party, and wherein said bag is provided free or at substantially no cost to the second party.

14. The bag of claim 13, wherein the bag comprises a bag selected from the group consisting of a paper bag, a compostable bag, a plastic bag, and mixtures thereof.

15. The bag of claim 14, wherein the bag is a compostable bag.

16. The bag of claim 13, wherein the bag further comprises a slogan or a logo representing the second party.

17. A method of coordinating third party advertising on consumer bags comprising the steps of:
(a) contacting a first party to manufacture at least one compostable bag;
(b) contacting a second party to receive the bag at a substantially minimal or free price for consumer use;
(c) contacting a third party to solicit advertising;
(d) providing said advertising to first party by coordinating effective manufacturing machining;
(e) monitoring distribution of the bag or bags from first party to second party and then to consumers; and
(f) reporting distribution to third party and soliciting additional advertising.

18. The method of claim 18, wherein the effective manufacturing machining comprises selecting a plate representing said advertising.

19. The method of claim 19, wherein the plate is owned by a fourth party.

20. The method of claim 18, wherein said method is performed by any one of the first party, second party, third party, or fourth party
